(19) United States
(12) Patent Application Publication
(10) Pub. No.: US 2026/0118861 A1
(43) Pub. Date: Apr. 30, 2026

(54) INFORMATION PROCESSING METHOD, COMPUTER PROGRAM, AND INFORMATION PROCESSING APPARATUS

(71) Applicant: Tokyo Electron Limited, Tokyo (JP)

(72) Inventor: Ryoji ANZAKI, Tokyo (JP)

(73) Assignee: Tokyo Electron Limited, Tokyo (JP)

(21) Appl. No.: 19/433,274

(22) Filed: Dec. 26, 2025

Related U.S. Application Data
(63) Continuation of application No. PCT/JP2024/022391, filed on Jun. 20, 2024.

(30) Foreign Application Priority Data
Jun. 27, 2023 (JP) 2023-105034

(51) Int. Cl. G05B 19/418; G05B 23/02

(52) U.S. Cl. CPC G05B 19/41885; G05B 23/0235; G05B 2219/45031; G05B 2219/45212

(57) ABSTRACT

To provide an information processing method in which an information processing apparatus performs a simulation using a large-scale model including a plurality of small-scale models, and the information processing method includes: by the information processing apparatus, storing a correspondence between input data and output data for a given small-scale model in the large-scale model in advance in a storage, when data is input into the given small-scale model in the simulation, generating a surrogate model representing the given small-scale model within a local range that includes the data that is input, based on data stored in advance in the storage, and generating output data corresponding to the input data to the given small-scale model, using the generated surrogate model.

### CROSS-REFERENCE TO RELATED APPLICATIONS

This application is a bypass continuation application of international application No. PCT/JP2024/022391 having an international filing date of Jun. 20, 2024 and designating the United States, the international application being based upon and claiming the benefit of priority from Japanese Patent Application No. 2023-105034, filed on Jun. 27, 2023, the entire contents of each are incorporated herein by reference.

### TECHNICAL FIELD

The present disclosure relates to an information processing method, a computer program, and an information processing apparatus.

### BACKGROUND

PTL 1 proposes a prediction method that includes an operation for obtaining a machine learning model that predicts a performance metric for an operation of a semiconductor manufacturing tool, and an operation for receiving a process definition for manufacturing a product with the semiconductor manufacturing tool, and uses one or more machine learning models to estimate performance of the process definition used in the semiconductor manufacturing tool and presents an estimation result of performance of manufacturing the product on a display.

### CITATION LIST

### Patent Documents

PTL 1: JP2023-511122A

### SUMMARY

The present disclosure provides an information processing method, a computer program, and an information processing apparatus which can be expected to speed up verification or the like using a large-scale model.
(1) The information processing method according to one or more embodiments includes, by an information processing apparatus, performing a simulation using a large-scale model including a plurality of small-scale models, and the information processing method includes: by the information processing apparatus, storing a correspondence between input data and output data for a given small-scale model in the large-scale model in advance in a storage, when data is input into the given small-scale model in the simulation, generating a surrogate model representing the given small-scale model within a local range that includes the data that is input, based on data stored in advance in the storage, and generating output data corresponding to the input data to the given small-scale model, using the generated surrogate model to predict an etch rate of the etching process based on set voltage and set temperature inputs to a target apparatus, detect an abnormality therein by comparing the predicted etch rate to a measured etch rate from the substrate processing apparatus, and iteratively update the set voltage and set temperature inputs based on an error between the predicted etch rate and a target etch rate to achieve the target etch rate.
(2) The information processing method according to (1), further comprising:
   determining whether update of the generated surrogate model is necessary according to the input data to the given small-scale model, and
   when determining that the update is necessary, generating a surrogate model corresponding to the input data based on data stored in advance in the storage.
(3) The information processing method according to (2), further comprising:
   storing the generated one or more surrogate models in the storage,
   when the surrogate model corresponding to the input data is stored in the storage, determining that the update of the surrogate model is unnecessary, and
   generating the output data using the surrogate model stored in the storage.
(4) The information processing method according to (2), further comprising:
   when the input data to the given small-scale model exceeds a local range guaranteed by the surrogate model, determining that the update of the surrogate model is necessary.
(5) The information processing method according to (2), further comprising:
   acquiring information related to accuracy required for the output data output by the surrogate model, and
   when the accuracy related to the information acquired is not satisfied by the output data of the surrogate model, determining that the update of the surrogate model is necessary.
(6) The information processing method according to (1), further comprising: selecting input data and output data used for generating the surrogate model from the input data and the output data stored in the storage according to the input data to the given small-scale model, and
   generating the surrogate model based on the selected input data and output data.
(7) The information processing method according to (6), wherein
   the storage groups and stores a set of input data and output data according to a value of the input data or the output data.
(8) The information processing method according to (1), further comprising:
   comparing an actual measurement value obtained by measuring an operation of the target apparatus with a predicted value obtained by the simulation using the large-scale model that models the target apparatus, and
   detecting the abnormality in the target apparatus based on a comparison result.
(9) The information processing method according to (1), further comprising:
   predicting, based on input data to the target apparatus, output data of the target apparatus for the input data by the simulation using the large-scale model that models the target apparatus,
   calculating an error between a predicted value of the output data and a target value,
   updating the input data based on the calculated error, and
   repeating the prediction of the output data, the calculation of the error, and the updating of the input data to determine input data to the target apparatus that achieves the target value.
(10) A non-transitory computer readable medium causing a computer to perform a simulation using a large-scale model including a plurality of small-scale models, the computer program causing the computer to execute processing of
   storing a correspondence between input data and output data for a given small-scale model in the large-scale model in advance in a storage,
   when data is input into the given small-scale model in the simulation, generating a surrogate model representing the given small-scale model within a local range that includes the data that is input, based on data stored in advance in the storage, and
   generating output data corresponding to the input data to the given small-scale model, using the generated surrogate model to predict an etch rate of the etching process based on set voltage and set temperature inputs to the substrate processing apparatus, detect an abnormality therein by comparing the predicted etch rate to a measured etch rate from the substrate processing apparatus, and iteratively update the set voltage and set temperature inputs based on an error between the predicted etch rate and a target etch rate to achieve the target etch rate.
(11) An information processing apparatus comprising:
   a processor configured to perform a simulation using a large-scale model including a plurality of small-scale models, wherein
   the processor
   stores a correspondence between input data and output data for a given small-scale model in the large-scale model in advance in a storage,
   when data is input into the given small-scale model in the simulation, generates a surrogate model representing the given small-scale model within a local range that includes the data that is input, based on data stored in advance in the storage, and
   generates output data corresponding to the input data to the given small-scale model, using the generated surrogate model to predict an etch rate of the etching process based on set voltage and set temperature inputs to the substrate processing apparatus, detect an abnormality therein by comparing the predicted etch rate to a measured etch rate from the substrate processing apparatus, and iteratively update the set voltage and set temperature inputs based on an error between the predicted etch rate and a target etch rate to achieve the target etch rate.
(12) The information processing method according to (1), wherein the surrogate model is generated using one or more of Dynamic Mode Decomposition (DMD), Sparse Identification of Nonlinear Dynamical systems (SINDy), least squares method, spline interpolation, machine learning, or genetic algorithm.
(13) The information processing method according to (2), wherein the determining whether update of the generated surrogate model is necessary includes determining that the update is necessary when a value of the input data changes beyond a threshold associated with the local range.
(14) The information processing method according to (3), further comprising: saving a plurality of previously generated surrogate models in the storage, each having a different local range; and selecting one of the saved surrogate models based on the input data.
(15) The information processing method according to (6), wherein the selecting input data and output data includes classifying the input data into clusters using an unsupervised learning clustering method.
(16) The information processing method according to (8), wherein the detecting an abnormality includes determining the abnormality when the difference between the actual measurement value and the predicted value exceeds a predetermined threshold value.
(17) The non-transitory computer readable medium according to (10), wherein the processing of generating the surrogate model includes thinning out the selected data to not exceed an upper limit value based on a configuration of the surrogate model.
(18) The information processing apparatus according to (11), wherein the processor is further configured to group and store sets of the input data and output data in the storage according to values of the input data or the output data.
(19) The information processing apparatus according to (11), wherein the processor is further configured to reuse parameters from a previously generated surrogate model as initial values when generating a new surrogate model to improve accuracy.
(20) The information processing apparatus according to (19), wherein the reuse of parameters includes using coefficients from a linear surrogate model as initial coefficients in a quadratic surrogate model.

According to the present disclosure, it can be expected to speed up verification or the like using the large-scale model.

### BRIEF DESCRIPTION OF DRAWINGS

FIG. 1 is a schematic diagram illustrating an overview of an information processing system according to one or more embodiments;

FIG. 2 is a schematic diagram illustrating an overview of the information processing system according to one or more embodiments;

FIG. 3 is a block diagram illustrating a configuration example of an information processing apparatus according to one or more embodiments;

FIG. 4 is a schematic diagram illustrating a surrogate model;

FIG. 5 is a flowchart illustrating an example of a procedure of surrogate model generation processing performed by the information processing apparatus according to one or more embodiments;

FIG. 6 is a flowchart illustrating an example of a procedure of abnormality determination processing performed by the information processing apparatus according to one or more embodiments; and

FIG. 7 is a flowchart illustrating an example of a procedure of optimization processing performed by the information processing apparatus according to one or more embodiments.

### DETAILED DESCRIPTION

Hereinafter, a specific example of an information processing system according to the embodiment of the present disclosure will be described with reference to the drawings. The present disclosure is not limited to these examples, and is defined by the claims, and is intended to include all modifications within the meaning and scope equivalent to the claims.

### System Overview

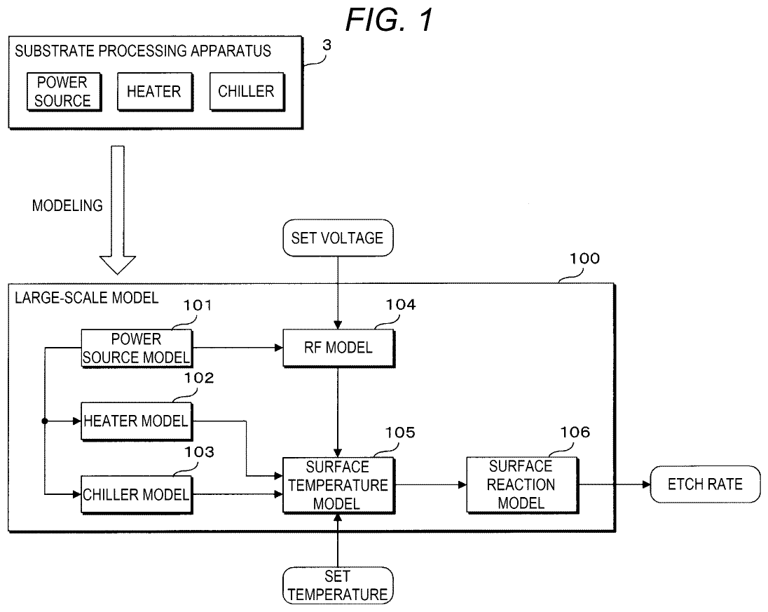

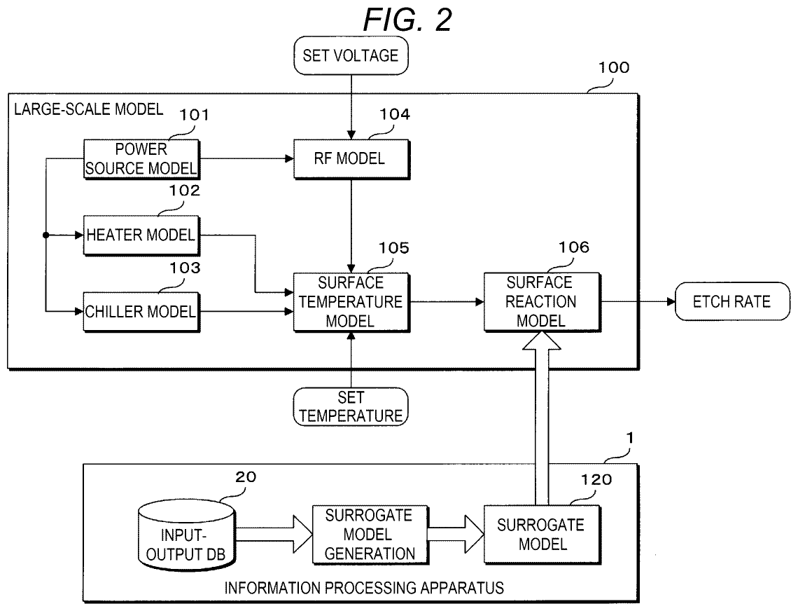

FIGS. 1 and 2 are schematic diagrams illustrating an overview of an information processing system according to one or more embodiments. The information processing system according to one or more embodiments is a system that reproduces a physical system present in a real space (physical space) in a virtual space (digital space or cyberspace), and performs management and control of the physical system. This is a technique that can be referred to as a so-called digital twin. In one or more embodiments, the information processing system handles, as an example of the physical system, a digital twin in which a substrate processing apparatus 3 for performing substrate processing such as manufacturing of a semiconductor wafer is reproduced in a virtual space. The physical system handled by the information processing system according to one or more embodiments is not limited to the substrate processing apparatus 3. The information processing system can be applied to any physical system that can be virtualized, such as via a digital twin.

In a digital twin technique, for example, as illustrated in FIG. 1, a large-scale model 100 that models the substrate processing apparatus 3 is created based on various types of data collected by the substrate processing apparatus 3. In one or more embodiments, the large-scale model includes, for example, a power source model 101, a heater model 102, and a chiller model 103 as small-scale models which are individual models of a plurality of components that make up the substrate processing apparatus 3, such as a power source, a heater, and a chiller. In addition, in the present example, the large-scale model 100 includes various small-scale models such as a radio frequency (RF) model 104, a surface temperature model 105, and a surface reaction model 106.

The large-scale model 100 according to one or more embodiments is configured to simulate operations, processing, or the like of the components to which these small-scale models correspond, and to exchange data of simulation results between the small-scale models, thereby enabling a simulation of the entire operation, processing, or the like of the substrate processing apparatus 3. In the present example, the large-scale model 100 is configured to perform a simulation of an etching process based on input data of a set voltage and a set temperature of the substrate processing apparatus 3, and to output a predicted value of an etch rate in the etching process as output data as a simulation result. In one or more embodiments, an etching process will be described by way of example. However, processing of performing a simulation using the large-scale model 100 is not limited to the etching process, and may be various types of processing.

The power source model 101 in the large-scale model 100 in the present example is a model of the power source of the substrate processing apparatus 3, and provides output data obtained as a result of simulating an operation of the power source to the heater model 102, the chiller model 103, and the RF model 104. The heater model 102 is a model of the heater in the substrate processing apparatus 3. The heater model 102 simulates an operation of the heater based on input data from the power source model 101, and provides output data of a simulation result to the surface temperature model 105. The chiller model 103 is a model of the chiller in the substrate processing apparatus 3. The chiller model 103 simulates an operation of the chiller based on input data from the power source model 101, and provides output data of a simulation result to the surface temperature model 105.

The RF model 104 is a model of, for example, a radio-frequency circuit (not illustrated) provided in the substrate processing apparatus 3. The RF model 104 simulates an operation of the radio-frequency circuit based on input data from the power source model 101, and provides output data as a simulation result to the surface temperature model 105. The surface temperature model 105 is a model of surface temperature characteristics of a substrate, such as a surface temperature (including surface temperature distribution) of a wafer processed in the substrate processing apparatus 3. The surface temperature model 105 simulates changes in a surface temperature of the substrate based on input data provided from the heater model 102, the chiller model 103, and the RF model 104, and provides output data of a simulation result to the surface reaction model 106. In the present example, an etching process is assumed as the substrate processing performed by the substrate processing apparatus 3. The surface reaction model 106 is a model of reaction characteristics on the substrate surface during the etching process. The surface reaction model 106 simulates a reaction on the substrate surface during the etching process based on the input data provided from the surface temperature model 105, and outputs etch rate data as a simulation result.

By simulating the operation or processing of the substrate processing apparatus 3 using such a large-scale model 100, it is possible to predict a result of substrate processing performed by the substrate processing apparatus 3, detect an abnormality in the substrate processing apparatus 3, or search for an optimal set value for the substrate processing apparatus 3. For example, an etch rate obtained when the substrate processing apparatus 3 is operated at a certain set voltage and set temperature can be predicted by performing a simulation of the large-scale model 100 based on input data of the set voltage and the set temperature. For example, a predicted value of the etch rate output by the large-scale model 100 according to the input data of the set voltage and the set temperature and a measured value of the etch rate obtained as a result of operating the substrate processing apparatus 3 at the same set voltage and set temperature can be compared with each other, and when a difference between the predicted value and the measured value exceeds a threshold value, it can be determined that an abnormality occurs in the substrate processing apparatus 3. For example, by calculating an error between the predicted value of the etch rate output from the large-scale model 100 according to the input data of a certain set voltage and set temperature and a target value of the etch rate desired by a user, and repeating the simulation while increasing or decreasing the set voltage and the set temperature so as to reduce this error, the set voltage and the set temperature that can make the etch rate equal to or close to the target value can be obtained.

These small-scale models provided in the large-scale model 100 are created in advance by extracting input data to the components and output data of the components from data collected for the substrate processing apparatus 3, and adjusting parameters and the like of the model to reproduce a correspondence relationship between an input and an output based on the extracted data. The small-scale model may be represented by, for example, an arithmetic expression based on physical characteristics of the components, or may be, for example, a machine learning model such as a neural network, or may be a model having other configurations.

In the plurality of small-scale models in such a large-scale model 100, an amount of calculation involved in simulation processing of each small-scale model, an amount of data handled in the processing, time required for the processing, and the like vary. An amount of data required to generate the small-scale model and time required to generate the small-scale model also vary. In the present example, the power source model 101, the heater model 102, the chiller model 103, the RF model 104, and the surface temperature model 105 in the large-scale model 100 are models (i.e., light models) with a relatively small amount of calculation, processing time, generation time, and the like, while the surface reaction model 106 is a model (i.e., heavy model) with a relatively large amount of calculation, processing time, generation time, and the like. Such a heavy model requires a large amount of data to generate an accurate model, and requires a large amount of time to generate the heavy model.

In the information processing system according to one or more embodiments, as illustrated in FIG. 2, an information processing apparatus 1 performing a simulation using the large-scale model 100 generates a surrogate model 120 that performs processing of the surface reaction model 106, which is a heavy model, on behalf of the surface reaction model 106. The surrogate model 120 is a model that does not represent processing for an entire range of possible input data values for the surface reaction model 106, but rather represents processing of the surface reaction model 106 only within a portion of the entire range of possible input data values. The surrogate model 120 is a model in which the amount of calculation, the processing time, the generation time, and the like are reduced by limiting a range of corresponding input data to a local range. In one or more embodiments, an example of generating the surrogate model 120 for a heavy model will be described. However, the invention is not limited to this, and the information processing apparatus 1 may generate the surrogate model 120 for a light model. The information processing apparatus 1 may generate the surrogate model 120 for the plurality of small-scale models in the large-scale model 100.

The information processing apparatus 1 according to one or more embodiments performs, for example, a simulation using the large-scale model 100, and generates the surrogate model 120 of the surface reaction model 106 at a point in time when processing of the surface reaction model 106 becomes necessary during the simulation. Therefore, the power source model 101, the heater model 102, the chiller model 103, the RF model 104, and the surface temperature model 105 in the large-scale model 100 need to be generated in advance at the start of the simulation. However, the surface temperature model 105 may not be generated in advance. To generate the surrogate model 120, the information processing apparatus 1 acquires in advance a correspondence between input data and output data of the surface reaction model 106, and stores the correspondence in an input-output DB (database) 20. The input data and the output data stored in the input-output DB 20 are, for example, a range and amount of data that can generate the surface reaction model 106 corresponding to an entire range of the input data.

The information processing apparatus 1 starts a simulation using the large-scale model 100, and when data that is output from the surface temperature model 105 and input into the surface reaction model 106 is calculated, the information processing apparatus 1 reads input data in a local range including a value of the input data and output data corresponding thereto from the input-output DB 20. The information processing apparatus 1 generates the surrogate model 120 based on the input data and the output data in the local range read from the input-output DB 20. The information processing apparatus 1 inputs output data of the surface temperature model 105 to the generated surrogate model 120, and acquires output data of the surrogate model 120 (i.e., predicted data of an etch rate in the present example), thereby performing a simulation of the large-scale model 100.

In the simulation using the large-scale model 100, the information processing apparatus 1 repeatedly performs calculations on the small-scale model, and repeatedly calculates a predicted value of the etch rate. At this time, data from the surface temperature model 105 is repeatedly input into the surface reaction model 106, and a value of input data changes each time. The information processing apparatus 1 monitors changes in values of input data from the surface temperature model 105 to the surface reaction model 106, and when a value that exceeds the local range to which the generated surrogate model 120 can correspond is input, the information processing apparatus 1 updates the surrogate model 120 by regenerating and replacing the surrogate model 120. By the information processing apparatus 1 updating the surrogate model 120 as necessary, the simulation using the large-scale model 100 can be maintained regardless of changes in a value of the input data to the surface reaction model 106.

### Apparatus Configuration

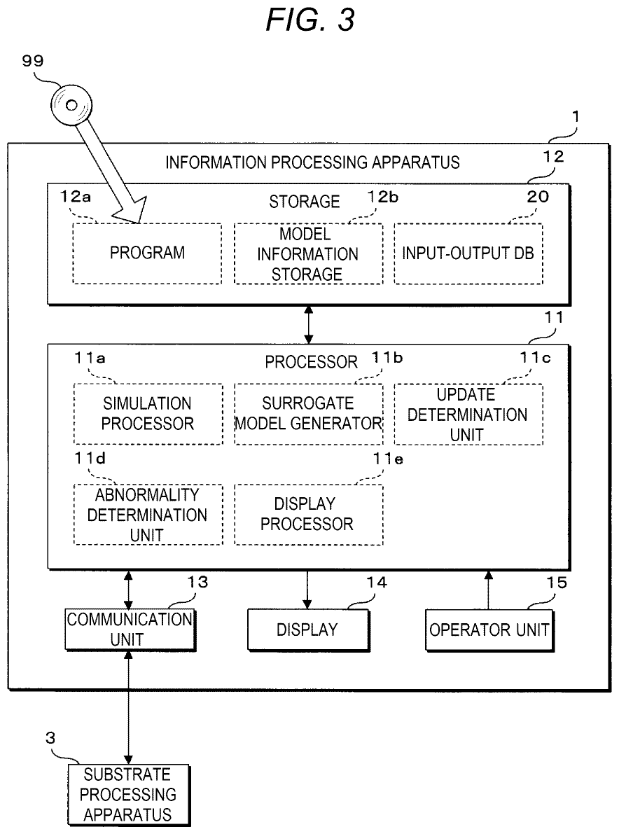

FIG. 3 is a block diagram showing a configuration example of the information processing apparatus 1 according to one or more embodiments. The information processing apparatus 1 according to one or more embodiments is an apparatus that uses, for example, the large-scale model 100 that models the substrate processing apparatus 3 or the like as a target apparatus, and predicts substrate processing results and detects abnormalities by the simulation or the like. The information processing apparatus 1 according to one or more embodiments is connected to the substrate processing apparatus 3 via, for example, a communication cable, and can acquire data from the substrate processing apparatus 3 and control the substrate processing apparatus 3 in accordance with results of prediction, abnormality detection, and the like. The information processing apparatus 1 does not need to be communicably connected to the substrate processing apparatus 3, and may only perform processing such as simulation using the large-scale model 100 without controlling the substrate processing apparatus 3 or the like.

The information processing apparatus 1 can be implemented by installing a computer program according to one or more embodiments in a general-purpose information processing apparatus such as a personal computer and a server computer. The information processing apparatus 1 according to one or more embodiments includes a processor 11, a storage 12, a communication unit 13, a display 14, an operator 15, and the like. In one or more embodiments, an example will be described in which a process is performed by one information processing apparatus 1. Meanwhile, the process of the information processing apparatus 1 may be distributed and performed by a plurality of apparatuses. The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium, such as a CD-ROM or DVD, and/or the memory of a FPGA or ASIC.

The processor 11 is configured by using an arithmetic processing apparatus such as a central processing unit (CPU), a micro-processing unit (MPU), a graphics processing unit (GPU), or a quantum processor, a read only memory (ROM), a random access memory (RAM), and the like. The processor 11 reads and executes a program 12a stored in the storage 12, thereby performing various types of processing such as the simulation using the large-scale model 100 of the substrate processing apparatus 3 and processing for generating one or more surrogate models of the small-scale model in the large-scale model 100, as necessary.

The storage 12 is configured by using, for example, a large-capacity storage apparatus such as a hard disk. The storage 12 stores various types of programs to be executed by the processor 11 and various types of data necessary for the process of the processor 11. In one or more embodiments, the storage 12 stores the program 12a to be executed by the processor 11. The storage 12 includes a model information storage 12b that stores information related to the large-scale model 100 of the substrate processing apparatus 3, and the input-output DB 20 that stores data used for model generation.

In one or more embodiments, the program (computer program, program product) 12a is provided in a form recorded on a recording medium 99 such as a memory card or an optical disc. The information processing apparatus 1 reads the program 12a from the recording medium 99, and stores the program 12a in the storage 12. However, for example, the program 12a may be written into the storage 12 during a manufacturing stage of the information processing apparatus 1. For example, as the program 12a, the information processing apparatus 1 may acquire those which are distributed by a remote server device or the like through communication. For example, the program 12a may be written into the storage 12 of the information processing apparatus 1 after a writing apparatus reads data recorded in the recording medium 99. The program 12a may be provided in the form of distribution through a network, or may be provided in the form recorded in the recording medium 99.

The model information storage 12b of the storage 12 stores information related to the large-scale model 100 of the substrate processing apparatus 3 generated in advance, and one or more small-scale models in the large-scale model 100. The information related to the large-scale model 100 may include, for example, what small-scale models are in the large-scale model 100 and how a plurality of small-scale models are connected to each other. The information related to the small-scale model may include, for example, information indicating a configuration of the model, and information such as internal parameters of the model determined by machine learning. The information processing apparatus 1 can configure the large-scale model 100 by reading these pieces of information stored in advance in the model information storage 12b to use it for processing such as the simulation of the substrate processing apparatus 3.

For example, in a case of the information processing system illustrated in FIGS. 1 and 2, information such as configurations of the models and values of internal parameters of the power source model 101, the heater model 102, the chiller model 103, the RF model 104, and the surface temperature model 105 is stored in advance in the model information storage 12b. The model information storage 12b may store, for example, information regarding the surface reaction model 106, such as input data and output data for this model, but does not store the values of the internal parameters in advance. Values of internal parameters of the surrogate model 120 of the surface reaction model 106 generated in surrogate model generation processing to be described later may be stored in the model information storage 12b.

Since a method of generating the large-scale model 100 of the substrate processing apparatus 3 and a plurality of small-scale models in the large-scale model 100 are existing technologies, detailed descriptions thereof will be omitted in one or more embodiments. The large-scale model 100 and the small-scale model can be generated, for example, by performing machine learning processing using various types of data obtained from the substrate processing apparatus 3. The generation of these models may be performed by the information processing apparatus 1, or the information processing apparatus 1 may acquire information on the model generated by an apparatus different from the information processing apparatus 1 and store the information in the model information storage 12b. In any case, in the information processing system according to one or more embodiments, the large-scale model 100 of the substrate processing apparatus 3 as illustrated in FIG. 1 is generated in advance by an appropriate method. The generated information about the large-scale model 100 and the small-scale model is stored in advance in the model information storage 12b to be used when the information processing apparatus 1 performs a simulation or the like of the substrate processing apparatus 3.

The input-output DB 20 is a database that stores data, e.g., in memory, necessary for generating the surrogate model 120. For example, the input-output DB 20 stores, in advance, data obtained by associating input data for the surrogate model 120 with output data output by the surrogate model 120 when this input data is input. In a case of the information processing systems illustrated in FIGS. 1 and 2, for example, temperature distribution data as input data from the surface temperature model 105 to the surface reaction model 106 and etch rate data when an etching process is performed for the input temperature distribution as output data of the surface reaction model 106 are stored in association with each other in the input-output DB 20. The temperature distribution data and etch rate data, and other data related to operating the substrate processing apparatus are collected in advance by measuring a temperature distribution and an etch rate when, for example, a designer of the present system performs an etching process in the substrate processing apparatus 3, and stored in the input-output DB 20.

The input-output DB 20 of the information processing apparatus 1 according to one or more embodiments associates input data and output data into one set, and groups and stores a plurality of sets of data based on values of the input data. For example, the information processing apparatus 1 can divide sets of input data and output data into groups by classifying the input data into a plurality of clusters by using an unsupervised learning clustering method. For example, the information processing apparatus 1 may perform grouping based on, for example, a range of values in the input data, or may arrange and store data in an ascending or descending order of any value in the input data. The grouping of the sets of input data and output data may be performed according to values of the output data, instead of performing the grouping according to values of the input data. The data stored in the input-output DB 20 may be added or deleted at an appropriate timing, and when the data is added, the information processing apparatus 1 classifies the data to be added into appropriate groups according to a given rule and stores the data.

The communication unit 13 is connected to the substrate processing apparatus 3 through a cable such as a communication line or a signal line, and transmits and receives data to and from the substrate processing apparatus 3 through the cable. In one or more embodiments, for example, the information processing apparatus 1 can acquire data obtained when the substrate processing apparatus 3 performs substrate processing, and perform processing such as predicting results of the substrate processing by a simulation using the large-scale model 100. For example, the information processing apparatus 1 can determine set values of the substrate processing apparatus 3 by a simulation using the large-scale model 100, and control an operation of the substrate processing apparatus 3 by transmitting the determined set values to the substrate processing apparatus 3. The communication unit 13 transmits data provided from the processor 11 to the substrate processing apparatus 3, receives data transmitted from the substrate processing apparatus 3, and provides the received data to the processor 11.

The display 14 is configured by using a liquid crystal display or the like, and displays various images, characters, and the like based on the process of the processor 11. In one or more embodiments, the display 14 displays, for example, information related to a result of a simulation using the large-scale model 100, and information related to an operating state of the substrate processing apparatus 3. The operator 15 receives a user operation and notifies the processor 11 of the received operation. For example, the operator 15 receives the user operation by an input device such as a mechanical button or a touch panel provided on a surface of the display 14. For example, the operator 15 may be an input device such as a mouse and a keyboard, and these input devices may be configured to be detachable from the information processing apparatus 1.

The storage 12 may be an external storage device connected to the information processing apparatus 1. The information processing apparatus 1 may be a multi-computer including a plurality of computers, or may be a virtual machine virtually constructed by software. In addition, the information processing apparatus 1 is not limited to the configuration described above, and does not need to include the display 14, the operator 15, and the like, for example.

In the information processing apparatus 1 according to one or more embodiments, the processor 11 reads and executes the program 12a stored in the storage 12, thereby implementing a simulation processor 11a, a surrogate model generator 11b, an update determination unit 11c, an abnormality determination unit 11d, a display processor 11e, and the like as software functional units in the processor 11.

The simulation processor 11a performs a simulation using the large-scale model 100 of the substrate processing apparatus 3 based on information stored in the model information storage 12b. The simulation processor 11a configures a plurality of small-scale models necessary based on the information stored in the model information storage 12b, and connects these small-scale models to configure the large-scale model 100. The simulation processor 11a acquires input data for the large-scale model 100 based on, for example, a simulation condition set by a user, inputs the acquired input data into a corresponding small-scale model, and acquires output data output by the small-scale model. The simulation processor 11a repeats inputting the output data of the small-scale model into the next small-scale model and acquiring the output data of the next small-scale model according to connection relationships of a plurality of small-scale models in the large-scale model 100, and uses data output from the last-stage small-scale model as the output data of the large-scale model 100, and uses this output data as a simulation result. The simulation processor 11a can input, for example, input data that changes in time series into the large-scale model 100 in order, and acquire output data that changes in time series as a simulation result from the large-scale model 100.

When the simulation processor 11a performs a simulation using the large-scale model 100, the surrogate model generator 11b performs processing to generate the surrogate model 120 of a specific small-scale model in the large-scale model 100. In one or more embodiments, the surrogate model 120 is a model that guarantees an operation in only a partial local range with respect to an entire range of input data to which the small-scale model corresponds. When input data is provided to a specific small-scale model in the simulation of the large-scale model 100, the surrogate model generator 11b acquires a set of input data and output data from the input-output DB 20 for a local range that includes the input data, and generates a surrogate model using the acquired data sets. As a method of generating the surrogate model 120 by the surrogate model generator 11b, various methods such as Dynamic Mode Decomposition (DMD), Sparse Identification of Nonlinear Dynamical systems (SINDy), least squares method, spline interpolation, machine learning, or genetic algorithm may be adopted.

The update determination unit 11c performs processing of determining whether an update of the surrogate model 120 generated by the surrogate model generator 11b is necessary. When input data is provided to a specific small-scale model in the simulation of the large-scale model 100, the update determination unit 11c determines whether the input data is within a range of input data guaranteed by the generated surrogate model 120. When the input data is within the guarantee range, the update determination unit 11c determines that the update of the surrogate model 120 is not necessary. When the input data is outside the guarantee range, the update determination unit 11c determines that the update is necessary. When the update is necessary, the update determination unit 11c causes the surrogate model generator 11b to generate the surrogate model 120 corresponding to new input data.

The abnormality determination unit 11d communicates with the substrate processing apparatus 3 through, for example, the communication unit 13, acquires a measured value related to substrate processing measured by a sensor or the like of the substrate processing apparatus 3, and compares the measured value with a predicted value predicted by a simulation performed by the simulation processor 11a using the large-scale model 100. The abnormality determination unit 11d calculates a difference value between the measured value and the predicted value, and determines that there is a possibility that an abnormality occurs in the substrate processing apparatus 3 when the difference value exceeds a predetermined threshold value.

The display processor 11e performs processing of displaying various characters and images on the display 14. In one or more embodiments, the display processor 11e displays various types of information, such as information related to a result of a simulation performed by the simulation processor 11a or information related to a result of abnormality determination of the substrate processing apparatus 3 performed by the abnormality determination unit 11d.

### Surrogate Model Generation Processing

In the information processing system according to one or more embodiments, for example, data collection is performed using various sensors, measurement apparatuses, or the like for the substrate processing apparatus 3 that is a simulation target, and the large-scale model 100 that models the substrate processing apparatus 3 is generated based on the collected data. At this time, in the information processing system according to one or more embodiments, for example, for the large-scale model 100 illustrated in FIGS. 1 and 2, a small-scale model other than the surface reaction model 106 is generated based on collected data. These small-scale models may be generated by the information processing apparatus 1 or by an apparatus different from the information processing apparatus 1. These small-scale models may have any configuration, and may be generated by various methods such as DMD, SINDy, least squares method, spline interpolation, machine learning, or genetic algorithm.

The information processing apparatus 1 according to one or more embodiments stores, in advance, in the model information storage 12b, small-scale models other than the surface reaction model 106, which are generated in advance by an appropriate method for the large-scale model 100 illustrated in, for example, FIGS. 1 and 2. For the surface reaction model 106 in the large-scale model 100, the information processing apparatus 1 stores, in advance, a large amount of data for generating the surrogate model 120 in the input-output DB 20. The data used to generate the surrogate model 120 is data obtained by extracting input data and output data to the surface reaction model 106 from a large amount of data collected with respect to the substrate processing apparatus 3 during the above-described data collection, and associating the extracted input data and output data with each other.

By performing a simulation using the large-scale model 100, the information processing apparatus 1 can predict the etch rate as a result of the etching process performed by the substrate processing apparatus 3 when, for example, a set temperature and a set voltage are determined. In this simulation, the information processing apparatus 1 individually performs the simulation for a plurality of small-scale models in the large-scale model 100, and exchanges simulation results between the small-scale models, so that a predicted value of the etch rate can be finally calculated. For example, in a case of the large-scale model 100 illustrated in FIGS. 1 and 2, the information processing apparatus 1 first performs a simulation of the power source model 101, and provides a simulation result to the heater model 102, the chiller model 103, and the RF model 104. The information processing apparatus 1 provides results of simulations of the heater model 102, the chiller model 103, and the RF model 104 to the surface temperature model 105. The information processing apparatus 1 performs a simulation of the surface temperature model 105 based on the simulation results of the heater model 102, the chiller model 103, and the RF model 104, calculates predicted values such as a surface temperature distribution of the substrate, and inputs the calculated values into the surface reaction model 106 as simulation results.

As described above, the surface reaction model 106 is not generated in advance. The information processing apparatus 1 according to one or more embodiments determines whether it is necessary to generate the surrogate model 120 of the surface reaction model 106 (whether an update is necessary) when data obtained from the simulation result of the surface temperature model 105 is input into the surface reaction model 106. When determining that it is necessary to generate the surrogate model 120, the information processing apparatus 1 acquires necessary data from the input-output DB 20 and generates the surrogate model 120 of the surface reaction model 106. The surrogate model 120 may have any configuration, and may be generated by various methods such as DMD, SINDy, least squares method, spline interpolation, machine learning, or genetic algorithm.

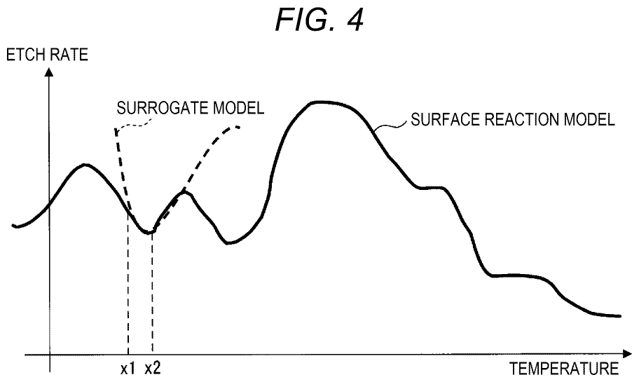

FIG. 4 is a schematic diagram illustrating the surrogate model 120. FIG. 4 is a two-dimensional graph illustrating an example of a correspondence relationship between input data and output data of the surface reaction model 106, and a horizontal axis (x-axis) of the graph is a temperature, which is the input data, and a vertical axis (y-axis) is an etch rate, which is the output data. In the present example, to simplify the description, both the input data and the output data of the surface reaction model 106 are one-dimensional (that is, one numerical value), but the present disclosure is not limited thereto, and the input data and the output data may be multi-dimensional vectors.

A curve indicated by a solid line in FIG. 4 represents a correspondence relationship between input and output of the surface reaction model 106 and includes a surrogate model that performs processing of the surface reaction model 106 and represents processing of the surface reaction model 106 within a portion of an entire range of input data values. This curve corresponds to a graph illustrating a relationship between the input data and the output data related to the surface reaction model 106 measured in advance in the substrate processing apparatus 3. At least an amount of data that can reproduce this graph is stored in the input-output DB 20. As illustrated in FIG. 4, the correspondence relationship between the input and output of the surface reaction model 106 is complex, and for example, when this graph is modeled by some mathematical formula, it is estimated that it is necessary to use a complex, high-dimensional mathematical formula.

The surrogate model 120 generated by the information processing apparatus 1 according to one or more embodiments is a model that reproduces only a part of the correspondence relationship between the input and output of the surface reaction model 106. The curve indicated by a broken line in FIG. 4 represents a correspondence relationship between input and output of the surrogate model 120 generated to represent the surface reaction model 106 for a local range of temperatures from x1 to x2. A guarantee range of the input data by the surrogate model 120 is narrowed to x1 to x2. However, for example, when modeling is performed only in this local range, it is expected that modeling can be performed using a low-dimensional mathematical formula of about second to third order.

The information processing apparatus 1 determines a local range that includes values of the input data from the surface temperature model 105 to the surface reaction model 106, and reads data in a range that can guarantee an operation of the model in this local range from the input-output DB 20 to generate the surrogate model 120. For example, the information processing apparatus 1 determines a local range x1 to x2 for input data x0 to the surface reaction model 106, and generates the surrogate model 120 by reading data in, for example, a range x3 to x4 as data necessary for generating the surrogate model 120 capable of guaranteeing an operation in the local range x1 to x2 (x3≤x1≤x0≤x2≤x4). The information processing apparatus 1 inputs input data from the surface temperature model 105 into the generated surrogate model 120, and acquires data of a predicted value of the etch rate output from the surrogate model 120. The information processing apparatus 1 can store the generated information about the surrogate model 120 in the storage 12 and reuse the information for subsequent processing.

Thereafter, when input data x5 from the surface temperature model 105 to the surrogate model 120 is within the guarantee range x1 to x2 (x1≤x5≤x2), the information processing apparatus 1 determines that an update of the surrogate model 120 is not necessary, and reuses the generated surrogate model 120 to calculate the predicted value of the etch rate. In contrast, thereafter, when the input data x5 from the surface temperature model 105 to the surrogate model 120 is outside the guarantee range x1 to x2 (x5<x1 or x5>x2), the information processing apparatus 1 determines that update of the surrogate model 120 is necessary, and generates the surrogate model 120 in a local range that includes the new input data x5.

Several methods may be considered for determining a data range used for the generation of the surrogate model 120.

### Data Range Determination Method 1

A first method is a method in which, for example, a range of x±r is set to be a guarantee range for the input data x to the surface reaction model 106, a range of x±rN is set to be a data range read from the input-output DB 20, and values of r and N are set in advance by a user such as a designer or an administrator of the present system. The information processing apparatus 1 receives and stores inputs of set values of r and N from the user. The information processing apparatus 1 reads data in the range of x±rN from the input-output DB 20 according to the set values stored when the surrogate model 120 is generated, and generates the surrogate model 120 based on the read data.

### Data Range Determination Method 2

A second method is a method of determining a data range, the number of data, or the like, based on an arithmetic expression for calculating a predetermined error and a value of an allowable error. For example, it is assumed that an order of the generated surrogate model 120 is n, the data range used for the generation of the surrogate model 120 is D=xₘₐₓ−xₘᵢₙ, the number of data is M, and an error in a value output by the surrogate model 120 is calculated using an arithmetic expression such as Error(D, M, n)=Dₐ×M_{b}×n_{c}. When an allowable error is Acc, an inequality Error(D, M, n)<Acc can be obtained.

Here, for example, when the order n=2 of the surrogate model 120 is determined and the number M of data used for generation is determined, an only unknown quantity in the arithmetic expression for the error Error is the range D in which the error Error is smaller than the allowable error Acc, so it is possible to calculate the range D. After calculating the range D, the information processing apparatus 1 can generate the surrogate model 120 by using data about the range D that includes the input data x to the surface reaction model 106, for example, data about a range from x−D/2 to x+D/2.

Based on the above inequality, the order n or the number of data M may be determined, instead of the data range D. For example, when the order n=2 of the surrogate model 120 is determined and the data range D is determined by an appropriate method (for example, based on “Data Range Determination Method 1” described above), the number of data M can be calculated based on the above inequality. The similar applies to the order n.

In the present example, the arithmetic expression for calculating the error Error is Error(D, M, n)=Dₐ×M_{b}×n_{c}. However, the arithmetic expression is not limited thereto, and any arithmetic expression may be used. This arithmetic expression is determined in advance by, for example, a designer or administrator of the information processing system, and is stored in advance in the storage 12 of the information processing apparatus 1.

When any of the above-described methods is adopted, if all data in the determined range is read from the input-output DB 20 and the surrogate model 120 is generated, generation time may increase when an amount of data is large. In this case, the information processing apparatus 1 may generate the surrogate model 120 by thinning the data as appropriate, instead of using the entire data within the determined range. The information processing apparatus 1 may select a given number of pieces of data randomly from the data in the determined range to thin out the data, may select the data at equal intervals in a storage order of the data stored in the input-output DB 20 to thin out the data, or may thin out the data by other methods.

Whether the information processing apparatus 1 thins out data may be preset by the user, for example. For example, a maximum value for the number or amount of data used by the user when the surrogate model 120 is generated is set, and when target data stored in the input-output DB 20 exceeds the set number or amount, the information processing apparatus 1 thins out the data to generate the surrogate model 120. For example, the user can set an upper limit value for time required for processing of generating the surrogate model 120, estimate time required for the information processing apparatus 1 to generate the surrogate model 120 based on a configuration of the surrogate model 120, an amount of parameter, and the like, and thin out the data so as not to exceed the set upper limit value.

The information processing apparatus 1 that has generated the surrogate model 120 using the data stored in the input-output DB 20 inputs input data to the surface reaction model 106 into the surrogate model 120, acquires output data output from the surrogate model 120 in response to the input data, and provides the output data as output data of the surface reaction model 106 to a subsequent small-scale model or the like. The information processing apparatus 1 stores information about the generated surrogate model 120 in the storage 12, and thereafter, can read and use the generated surrogate model 120 from the storage 12 as long as data input to the surface reaction model 106 is within a range guaranteed by the stored surrogate model 120. The information processing apparatus 1 preferably stores, as information related to the surrogate model 120, for example, information related to a structure of the surrogate model 120 and internal parameters, as well as information related to a range of values of input data guaranteed by the surrogate model 120.

The information processing apparatus 1 needs to generate and update the surrogate model 120 when the data input to the surface reaction model 106 is not within the range guaranteed by the stored surrogate model 120. However, at this time, the former surrogate model 120 may be saved without being deleted from the storage 12. Accordingly, if the input to the surface reaction model 106 is within the guarantee range of the stored surrogate model 120, the information processing apparatus 1 can reuse the saved surrogate model 120 without generating the surrogate model 120 again. The information processing apparatus 1 may generate a plurality of surrogate models 120 having different guarantee ranges, and store the generated surrogate models 120 in the storage 12. When the information processing apparatus 1 generates and stores the surrogate model 120 in this way to store the surrogate model 120 sufficient to cover an entire range of input data of the surface reaction model 106, the generated surrogate model 120 may be appropriately selected and used thereafter, and the information processing apparatus 1 does not need to generate the surrogate model 120.

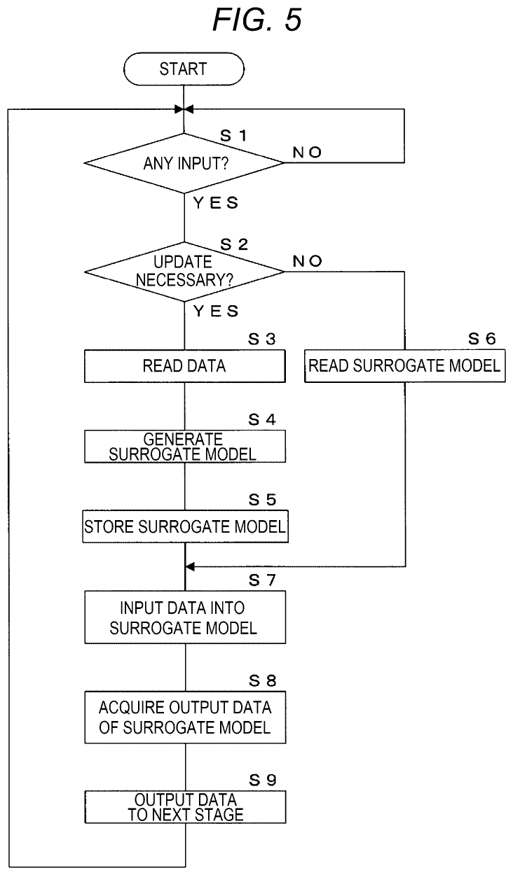

FIG. 5 is a flowchart illustrating an example of a procedure of surrogate model generation processing performed by the information processing apparatus 1 according to one or more embodiments. The simulation processor 11a of the processor 11 of the information processing apparatus 1 according to one or more embodiments performs a simulation of the substrate processing apparatus 3 using the large-scale model 100. In this simulation, the processor 11 determines whether data is input from another small-scale model to a small-scale model in the large-scale model 100 that is a representative target, for example, the surface reaction model 106 (step S1). If there is no input to the surface reaction model 106 (S1: NO), the processor 11 continues the simulation using the large-scale model 100 until the data is input to the surface reaction model 106.

If the data is input into the surface reaction model 106 (S1: YES), the update determination unit 11c of the processor 11 determines whether it is necessary to update the surrogate model 120 of the surface reaction model 106 based on the data input into the surface reaction model 106 (step S2). If it is necessary to update the surrogate model 120 (S2: YES), the surrogate model generator 11b of the processor 11 reads data of a local range according to the data input to the surface reaction model 106 from data stored in the input-output DB 20 (step S3). The surrogate model generator 11b generates the surrogate model 120 of the surface reaction model 106 based on data obtained by associating input data and output data read from the input-output DB 20, using an existing model generation algorithm as appropriate (step S4). The surrogate model generator 11b stores information related to the generated surrogate model 120, for example, information indicating a structure of the surrogate model 120 and information such as internal parameters in the storage 12 (step S5), and advances the processing to step S7. If it is not necessary to update the surrogate model 120 (S2: NO), the processor 11 reads the information related to the surrogate model 120 stored in the storage 12 (step S6), and advances the processing to step S7.

After generating the surrogate model 120 in steps S3 to S5, or after reading the surrogate model 120 in step S6, the processor 11 inputs the input data input into the surface reaction model 106 in step S1 into the surrogate model 120 (step S7). The processor 11 acquires output data output from the surrogate model 120 in response to the data input in step S7 (step S8). The processor 11 provides the output data of the surrogate model 120 acquired in step S8 as the output data of the surface reaction model 106 to, for example, a next-stage small-scale model (step S9), and returns the processing to step S1.

### Modification

In the example described above, the information processing apparatus 1 determines whether it is necessary to update the surrogate model 120 based on whether the value of the input data input into the small-scale model that is a representative target of the surrogate model 120 is within the guarantee range of the surrogate model 120. However, a determination condition for determining necessity of the update is not limited thereto. The information processing apparatus 1 according to the modification determines whether an update is necessary, for example, according to accuracy of data required for output data of a small-scale model that is a representative target of the surrogate model 120. The information processing apparatus 1 according to the modification receives a setting related to accuracy of a simulation, a setting related to accuracy of the surrogate model 120, or the like from a user.

The surrogate model generator 11b of the information processing apparatus 1 according to the modification generates the surrogate model 120 capable of outputting output data according to accuracy set by the user. The surrogate model generator 11b can change accuracy of the output data of the surrogate model 120 by changing a configuration of the surrogate model 120, such as the number of parameters or the number of terms in an arithmetic expression in the surrogate model 120. For example, the surrogate model generator 11b can change the accuracy of the output data of the generated surrogate model 120 by increasing or decreasing the number of sets of input data and output data read from the input-output DB 20 and used for generation. For example, the surrogate model generator 11b can change the accuracy of the output data of the surrogate model 120 by increasing or decreasing a range of values of input data guaranteed by the surrogate model 120. The surrogate model generator 11b may change the accuracy of the output data of the surrogate model 120 by any of these methods, may adopt other methods, or may use a plurality of methods in combination.

When the surrogate model generator 11b generates the surrogate model 120, the surrogate model generator 11b can use information about the already generated surrogate model 120, such as internal parameters. For example, in a situation where the surrogate model 120 represented by a linear function (y=bx+c) has been generated, the surrogate model generator 11b may generate the surrogate model 120 of a quadratic function (y=ax²+bx+c) to improve accuracy. In this case, the surrogate model generator 11b can generate the surrogate model 120 of the quadratic function with improved accuracy by using values of the parameters (coefficients) b and c of the generated surrogate model 120 of the linear function as they are as the parameters b and c of the surrogate model 120 of the quadratic function, and determining a value of the new parameter a of the quadratic function using data in the input-output DB 20.

In this case, the surrogate model generator 11b may not use the parameters b and c as they are, but may use the parameters b and c as initial values of the parameters b and c of the surrogate model 120 of the new quadratic function, and determine final values of the parameters b and c based on the initial values. The reuse of the parameters described above is merely an example, and is not limited thereto, and the surrogate model generator 11b may generate a new surrogate model 120 using any information of the generated surrogate model 120.

The information processing apparatus 1 according to the modification stores, in the storage 12, information related to a range of values of input data guaranteed by the surrogate model 120 and information related to accuracy output by the surrogate model 120 in association with each other together with information such as the configuration and parameters of the generated surrogate model 120. The information processing apparatus 1 according to the modification can acquire a setting of accuracy by the user, and determine whether it is necessary to update the surrogate model 120 based on whether the stored surrogate model 120 matches the accuracy setting.

### Examples of Utilization

Several examples of utilization of the information processing system according to one or more embodiments will be described. A first example of utilization is abnormality determination of the substrate processing apparatus 3. The information processing apparatus 1 can determine an abnormality of an arm device that transfers a substrate as the substrate processing apparatus 3 by using the large-scale model 100 that models the arm device. The large-scale model 100 receives, for example, a torque of the arm device as input data, and outputs a predicted value of a movement speed of an arm as output data. The information processing apparatus 1 acquires input data of the torque to the arm device, performs a simulation of the large-scale model 100, and predicts the movement speed of the arm of the arm device according to the input torque. The information processing apparatus 1 acquires an actual measurement value of the movement speed of the arm of the arm device according to the same input data, and determines that an abnormality occurs in the arm device when a difference value between the predicted value and the actual measurement value of the movement speed exceeds a predetermined threshold value.

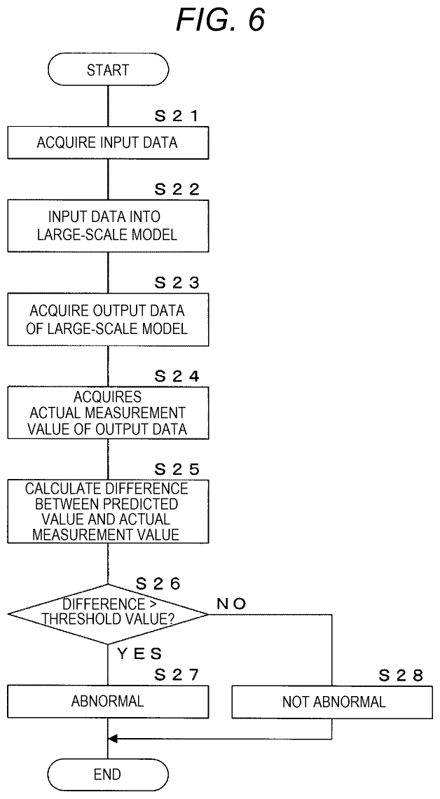

FIG. 6 is a flowchart illustrating an example of a procedure of abnormality determination processing performed by the information processing apparatus 1 according to one or more embodiments. The abnormality determination unit 11d of the processor 11 of the information processing apparatus 1 according to one or more embodiments communicates with the substrate processing apparatus 3 through, for example, the communication unit 13, and acquires input data of a torque for the arm device (step S21). The simulation processor 11a of the processor 11 inputs the acquired input data into the large-scale model 100 (step S22), and performs a simulation of an operation of the substrate processing apparatus 3 using the large-scale model 100. At this time, the information processing apparatus 1 according to one or more embodiments can perform a simulation using the above-described surrogate model 120 with respect to one or more small-scale model in the large-scale model 100.

The simulation processor 11a acquires output data output by the large-scale model 100 by the simulation (step S23). The abnormality determination unit 11d communicates with the substrate processing apparatus 3 through, for example, the communication unit 13, and acquires an actual measurement value of a movement speed of the arm device with respect to the input data acquired in step S21 (step S24). The abnormality determination unit 11d calculates a difference between a predicted value of the output data acquired in step S23 and the actual measurement value of output data acquired in step S24 (step S25). The abnormality determination unit 11d determines whether the difference calculated in step S25 exceeds a predetermined threshold value (step S26). If the difference exceeds the threshold value (step S26: YES), the abnormality determination unit 11d determines that there is an abnormality in the substrate processing apparatus 3 (step S27), and the processing ends. If the difference does not exceed the threshold value (step S26: NO), the abnormality determination unit 11d determines that there is no abnormality in the substrate processing apparatus 3 (step S28), and the processing ends.

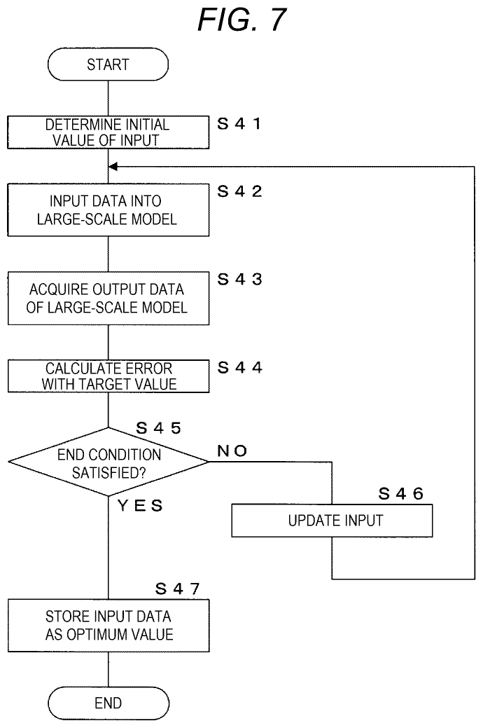

A second example of utilization is optimization of a setting of the substrate processing apparatus 3. The information processing apparatus 1 allows the user to set a target value for a result of substrate processing performed by the substrate processing apparatus 3, for example, an etch rate, and optimizes a setting of the substrate processing apparatus 3 to achieve this target value. FIG. 7 is a flowchart illustrating an example of a procedure of optimization processing performed by the information processing apparatus 1 according to one or more embodiments. The processor 11 of the information processing apparatus 1 according to one or more embodiments determines an initial value of the setting of the substrate processing apparatus 3 that is an optimization target, i.e., an initial value of input data to the large-scale model 100 (step S41). The determination of the initial value may be performed by the user, and in this case, the information processing apparatus 1 determines the initial value by receiving an input from the user.

The simulation processor 11a of the processor 11 inputs the determined or updated input data into the large-scale model 100 that models the substrate processing apparatus 3 (step S42), and performs a simulation of an operation of the substrate processing apparatus 3 using the large-scale model 100. At this time, the information processing apparatus 1 according to one or more embodiments can perform a simulation using the above-described surrogate model 120 with respect to one or more small-scale model in the large-scale model 100. The simulation processor 11a acquires output data output by the large-scale model 100 by the simulation (step S43).

The processor 11 calculates an error between a target value set in advance and a value of the output data acquired in step S43 (step S44). Next, the processor 11 determines whether an optimization end condition such as the error calculated in step S44 being smaller than a given threshold value is satisfied (step S45), for example. The end condition may include not only a condition based on an error but also various conditions such as the fact that processing time reaches an upper limit or the number of repetitions reaches an upper limit.

If the end condition is not satisfied (S45: NO), the processor 11 updates input data to the large-scale model 100 such that the output data approaches the target value based on an existing algorithm such as steepest descent method or Newton method, for example (step S46), and returns the processing to step S42. By repeating the processing of steps S42 to S46 until the end condition is satisfied, the processor 11 can optimize the input data to the large-scale model 100, i.e., optimize a set value or the like to be input to the substrate processing apparatus 3. If the end condition is satisfied (step S45: YES), the processor 11 stores a value of the input data at this point in time as an optimum value in the storage 12 (step S47), and ends the processing.

### Summary

In the information processing system according to one or more embodiments having the configuration described above, the information processing apparatus 1 performs a simulation or the like using the large-scale model 100 including a plurality of small-scale models. The information processing apparatus 1 stores, in advance, a correspondence between input data and output data for a given small-scale model (e.g., the surface reaction model 106) in the large-scale model 100 in the input-output DB 20 of the storage 12. The other small-scale models in the large-scale model 100 are generated in advance, and information such as parameters is stored in the model information storage 12b. However, the given small-scale model is not generated in advance, and the large-scale model 100 includes information such as a format of input and output data related to the given small-scale model. When data is input into this given small-scale model in the simulation using the large-scale model 100, the information processing apparatus 1 generates the surrogate model 120 representing respective small-scale models within a local range that includes the data that is input, based on data stored in the input-output DB 20. The information processing apparatus 1 uses the generated surrogate model 120 to input data for a given small-scale model into the surrogate model 120, and acquires output data output by the surrogate model 120, thereby generating output data corresponding to the input data to the given small-scale model.

Accordingly, the information processing system according to one or more embodiments does not need to generate in advance a small-scale model in which, for example, it is difficult to perform modeling or it takes time for modeling for an entire range of input and output, and thus can perform a simulation using the large-scale model 100 at an early stage. The local surrogate model 120 can be generated in a short time, and a simulation using the surrogate model 120 can also be performed at high speed. Therefore, compared with a case where all the small-scale models of the large-scale model 100 are generated in advance and a simulation is performed, the information processing system according to one or more embodiments can be expected to reduce time required from modeling of a target apparatus to completion of the simulation, and can be expected to speed up verification by the simulation or the like using the large-scale model.

In the information processing system according to one or more embodiments, the information processing apparatus 1 determines whether to update the generated surrogate model 120, based on data input into a given small-scale model in a simulation using the large-scale model 100. When it is determined that the update is necessary, the information processing apparatus 1 generates the surrogate model 120 according to the data input into the small-scale model, based on the data stored in the input-output DB 20. By performing the generation of the surrogate model 120 not each time, but only when it is determined that the generation is necessary, the information processing system according to one or more embodiments can be expected to reduce time of the simulation using the large-scale model 100 compared with a case where the generation of the surrogate model 120 is performed each time.

In the information processing system according to one or more embodiments, the information processing apparatus 1 stores the generated surrogate model 120 in the storage 12. When determining whether the surrogate model 120 needs to be updated, the information processing apparatus 1 determines that the update is not necessary when the surrogate model 120 corresponding to the input data input into the given small-scale model has been already stored by a simulation using the large-scale model 100. The information processing apparatus 1 uses the generated surrogate model 120 stored in the storage 12 to generate output data of a given small-scale model according to the input data. Accordingly, the information processing system according to one or more embodiments can reuse the generated surrogate model 120 once the surrogate model 120 has been generated, and thus can be expected to reduce generation frequency of the surrogate model 120 and speed up the simulation.

In the information processing system according to one or more embodiments, the information processing apparatus 1 determines that the update of the surrogate model 120 is necessary when the data input into the given small-scale model exceeds the local range guaranteed by the generated surrogate model 120. In the information processing system according to one or more embodiments, the information processing apparatus 1 acquires information related to accuracy required for the data output from the surrogate model 120, and determines that the update of the surrogate model 120 is necessary when the generated surrogate model 120 does not satisfy the accuracy. By determining whether an update is necessary based on these conditions, the information processing system according to one or more embodiments can be expected to appropriately generate the surrogate model 120.

In the information processing system according to one or more embodiments, the information processing apparatus 1 selects, from a set of input data and output data stored in the input-output DB 20, a set of input data and output data used for generating the surrogate model 120 corresponding to the input data to the given small-scale model, and generates the surrogate model 120 using the selected data. Accordingly, the information processing system according to one or more embodiments can be expected to select appropriate data for generating the surrogate model 120 capable of guaranteeing output data within the local range of input data from the large amount of data stored in the input-output DB 20.

In the information processing system according to one or more embodiments, the information processing apparatus 1 groups a set of input data and output data related to a given small-scale model collected in advance according to values of the input data or the output data, and stores the grouped data in the input-output DB 20. Accordingly, the information processing system according to one or more embodiments can be expected to facilitate selection of the set of input data and output data used for generating the surrogate model 120.

In the information processing system according to one or more embodiments, the information processing apparatus 1 compares an actual measurement value obtained by measuring an operation of a target apparatus such as the substrate processing apparatus 3 with a predicted value obtained by a simulation using the large-scale model 100 that models the target apparatus, and detects an abnormality in the target apparatus based on a comparison result. For example, when a difference between the actual measurement value and the predicted value exceeds a threshold value, the information processing apparatus 1 determines that there is an abnormality in the target apparatus. Accordingly, the information processing system according to one or more embodiments can be expected to accurately predict the operation of the target apparatus by a simulation using the large-scale model 100, and accurately determine an abnormality in the target apparatus.

In the information processing system according to one or more embodiments, the information processing apparatus 1 predicts output data of a target apparatus by a simulation using the large-scale model 100 based on input data to the target apparatus, calculates an error between a predicted value of the output data and a target value, and updates the input data to the target apparatus based on the calculated error. The information processing apparatus 1 repeats the simulation using the large-scale model 100 and the update of the input data based on the error to determine the input data to the target apparatus that achieves the target value. Accordingly, the information processing system according to one or more embodiments can be expected to achieve the target value by accurately determining input data for which the target apparatus can achieve the target value by a simulation using the large-scale model 100, and operating the target apparatus based on the determined input data.

The embodiments disclosed herein are exemplary in all respects and can be considered to be not restrictive. The scope of the present disclosure is indicated by the claims, not the above-described meaning, and is intended to include all modifications within the meaning and scope equivalent to the claims.

The features described in each embodiment can be combined with each other. In addition, the independent and dependent claims set forth in the claims can be combined with each other in any and all combinations, regardless of the reciting format. Furthermore, the claims use a format of describing claims that recite two or more other claims (multi-claim format). However, the present disclosure is not limited thereto. The claims may also be described using a format of multi-claims reciting at least one multi-claim (multi-multi claims). The present disclosure encompasses various modifications to each of the examples and embodiments discussed herein. According to the disclosure, one or more features described above in one embodiment or example can be equally applied to another embodiment or example described above. The features of one or more embodiments or examples described above can be combined into each of the embodiments or examples described above. Any full or partial combination of one or more embodiment or examples of the disclosure is also part of the disclosure.

1. An information processing method comprising:
by an information processing apparatus,
performing a simulation using a large-scale model including a plurality of small-scale models,
storing, a correspondence between input data and output data for a given small-scale model in the large-scale model in advance, in a storage,
when data is input into the given small-scale model in the simulation, generating a surrogate model representing the given small-scale model within a local range that includes the data that is input, based on data stored in advance in the storage, and
generating output data corresponding to the input data to the given small-scale model, using the generated surrogate model to optimize processing conditions of a target apparatus and/or determine an abnormality of the target apparatus based on a predicted value of processing of the target apparatus and an actually measured value.

2. The information processing method according to claim 1, further comprising, by the information processing apparatus:
determining whether update of the generated surrogate model is necessary according to the input data to the given small-scale model, and
when determining that the update is necessary, generating a surrogate model corresponding to the input data based on data stored in advance in the storage.

3. The information processing method according to claim 2, further comprising, by the information processing apparatus:
storing the generated one or more surrogate models in the storage,
when the surrogate model corresponding to the input data is stored in the storage, determining that the update of the surrogate model is unnecessary, and
generating the output data using the surrogate model stored in the storage.

4. The information processing method according to claim 2, further comprising, by the information processing apparatus:
when the input data to the given small-scale model exceeds a local range guaranteed by the surrogate model, determining that the update of the surrogate model is necessary.

5. The information processing method according to claim 2, further comprising, by the information processing apparatus:
acquiring information related to accuracy required for the output data output by the surrogate model, and
when the accuracy related to the information acquired is not satisfied by the output data of the surrogate model, determining that the update of the surrogate model is necessary.

6. The information processing method according to claim 1, further comprising, by the information processing apparatus:
selecting input data and output data used for generating the surrogate model from the input data and the output data stored in the storage according to the input data to the given small-scale model, and
generating the surrogate model based on the selected input data and output data.

7. The information processing method according to claim 6, further comprising, by the information processing apparatus:
causing the storage to group and store a set of input data and output data according to a value of the input data or the output data.

8. The information processing method according to claim 1, further comprising, by the information processing apparatus:
comparing an actual measurement value obtained by measuring an operation of the target apparatus with a predicted value obtained by the simulation using the large-scale model that models the target apparatus, and
detecting the abnormality in the target apparatus based on a comparison result.

9. The information processing method according to claim 1, further comprising, by the information processing apparatus:
predicting, based on input data to the target apparatus, output data of the target apparatus for the input data by the simulation using the large-scale model that models the target apparatus,
calculating an error between a predicted value of the output data and a target value,
updating the input data based on the calculated error, and
repeating the prediction of the output data, the calculation of the error, and the updating of the input data to determine input data to the target apparatus that achieves the target value.

10. A non-transitory computer readable medium comprising computer executable program code configured to cause a computer to execute processing of:
performing a simulation using a large-scale model including a plurality of small-scale models, storing a correspondence between input data and output data for a given small-scale model in the large-scale model in advance in a storage,
when data is input into the given small-scale model in the simulation, generating a surrogate model representing the given small-scale model within a local range that includes the data that is input, based on data stored in advance in the storage, and
generating output data corresponding to the input data to the given small-scale model, using the generated surrogate model to optimize processing conditions of a target apparatus and/or determine an abnormality of the target apparatus based on a predicted value of processing of the target apparatus and an actually measured value.

11. An information processing apparatus comprising:
a processor configured to perform a simulation using a large-scale model including a plurality of small-scale models, wherein
the processor
stores a correspondence between input data and output data for a given small-scale model in the large-scale model in advance in a storage,
when data is input into the given small-scale model in the simulation, generates a surrogate model representing the given small-scale model within a local range that includes the data that is input, based on data stored in advance in the storage, and
generates output data corresponding to the input data to the given small-scale model, using the generated surrogate model to optimize processing conditions of a target apparatus and/or determine an abnormality of the target apparatus based on a predicted value of processing of the target apparatus and an actually measured value.

12. The information processing method according to claim 1, wherein the surrogate model is generated using one or more of Dynamic Mode Decomposition (DMD), Sparse Identification of Nonlinear Dynamical systems (SINDy), least squares method, spline interpolation, machine learning, or genetic algorithm.

13. The information processing method according to claim 2, wherein the determining whether update of the generated surrogate model is necessary includes determining that the update is necessary when a value of the input data changes beyond a threshold associated with the local range.

14. The information processing method according to claim 3, further comprising: saving a plurality of previously generated surrogate models in the storage, each having a different local range; and selecting one of the saved surrogate models based on the input data.

15.-16. (canceled)

17. The non-transitory computer readable medium according to claim 10, wherein the processing of generating the surrogate model includes thinning out the selected data to not exceed an upper limit value based on a configuration of the surrogate model.

18. The information processing apparatus according to claim 11, wherein the processor is further configured to group and store sets of the input data and output data in the storage according to values of the input data or the output data.

19. The information processing apparatus according to claim 11, wherein the processor is further configured to reuse parameters from a previously generated surrogate model as initial values when generating a new surrogate model to improve accuracy.

20. The information processing apparatus according to claim 19, wherein the reuse of parameters includes using coefficients from a linear surrogate model as initial coefficients in a quadratic surrogate model.

21. The information processing method according to claim 9, wherein the target apparatus is a substrate processing apparatus, input data input to the large-scale model are setting conditions for the substrate processing apparatus, and output data of the large-scale model are results of operation or processing of the substrate processing apparatus.

22. The information processing method according to claim 9, wherein the generating the output data is further used to predict an etch rate of the etching process based on set voltage and set temperature inputs to the target apparatus, detect an abnormality therein by comparing the predicted etch rate to a measured etch rate from the substrate processing apparatus, and iteratively update the set voltage and set temperature inputs based on an error between the predicted etch rate and a target etch rate to achieve the target etch rate.
